(19) United States
(12) Patent Application Publication
(10) Pub. No.: US 2019/0061962 A1
(43) Pub. Date: Feb. 28, 2019

(54) PROPULSION AND ELECTRIC POWER GENERATION SYSTEM

(71) Applicant: HONEYWELL INTERNATIONAL INC., Morris Plains, NJ (US)

(72) Inventors: Nick Nolcheff, Chandler, AZ (US); John Meier, Phoenix, AZ (US); James Laffan, Phoenix, AZ (US); Alan D. Hemmingson, Tempe, AZ (US); Cristian Anghel, Oro Valley, AZ (US)

(73) Assignee: HONEYWELL INTERNATIONAL INC., Morris Plains, NJ (US)

(21) Appl. No.: 15/683,484

(22) Filed: Aug. 22, 2017

(51) Int. Cl. B64D 27/10; B64D 41/00; F02C 7/32

(52) U.S. Cl. CPC B64D 27/10; B64D 27/24; F02C 7/32; B64D 41/00

(57) ABSTRACT

A propulsion and electric power generation system includes a dual-spool turbofan gas turbine engine and an electrical generator. The dual-spool turbofan gas turbine engine includes at least a low-pressure turbine coupled to a fan via a low-pressure spool. The low-pressure turbine is configured to generate mechanical power. The electrical generator is directly connected to the low-pressure spool and is disposed downstream of the low-pressure turbine. A first fraction of the mechanical power generated by the low-pressure turbine is controllably supplied to the fan for propulsive power generation (Pₜ). A second fraction of the mechanical power generated by the low-pressure turbine is controllably supplied to the electrical generator for electrical power generation (Pₑ). A ratio of Pₑ to Pₜ (Pₑ/Pₜ), during operation of the dual-spool turbofan gas turbine engine, controllably spans a range from less than about 0.06 to at least 0.18.

### STATEMENT REGARDING FEDERALLY SPONSORED RESEARCH OR DEVELOPMENT

This invention was made with Government support under FA8650-15-D-2504-0001 awarded by the US Air Force Research Laboratory. The Government has certain rights in the invention.

### TECHNICAL FIELD

The present invention generally relates to turbofan gas turbine engines, and more particularly relates to a propulsion and electric power generation system that is implemented using a turbofan gas turbine engine.

### BACKGROUND

Electric power demand for aircraft continue to increase. Indeed, some aircraft demand relatively high power requirements—on the order of 1 megawatt—throughout the flight envelope. Even at relatively lower electric power demands, a traditional approach is to avoid encumbering the gas turbine engines responsible for providing thrust to the aircraft by using a separate, dedicated gas turbine engine, also known as an Independent Power Producer (IPU) OR Auxiliary Power Unit (APU), to address the need for electric power generation. The use of an IPU/APU resolves the challenges of simultaneously managing the variation in electric power demand and the variation in propulsion power demand.

As the ratio of power for electrical power generation (Pₑ) relative to the power for aircraft propulsive power generation for thrust (Pₜ) increases, the challenge of meeting both requirements (i.e., Pₑ and Pₜ) with a propulsion engine becomes increasingly difficult. This is because varying the power extraction from either the high-pressure spool and/or the low-pressure spool to drive a generator can detrimentally impact the stable operating range of the compressor. While the IPU/APU addresses certain challenges in delivering electric power, it adds significant cost, weight, and complexity to the aircraft system. Moreover, with the increase in electrical power demand at relatively high altitudes, the size, weight, and cost of the IPU/APU becomes increasingly prohibitive.

Hence, there is a need for an improved system that enables electric power extraction from the propulsion engine, particularly at high levels of Pₑ/Pₜ, without adversely impacting compressor operability and/or stall or surge margin The present invention addresses at least this need.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In one embodiment, a propulsion and electric power generation system includes a dual-spool turbofan gas turbine engine and an electrical generator. The dual-spool turbofan gas turbine engine includes at least a low-pressure turbine coupled to a fan via a low-pressure spool. The low-pressure turbine is configured to generate mechanical power. The electrical generator is directly connected to the low-pressure spool and is disposed downstream of the low-pressure turbine. A first fraction of the mechanical power generated by the low-pressure turbine is controllably supplied to the fan for propulsive power generation (Pₜ). A second fraction of the mechanical power generated by the low-pressure turbine is controllably supplied to the electrical generator for electrical power generation (Pₑ). A ratio of Pₑ to Pₜ (Pₑ/Pₜ), during operation of the dual-spool turbofan gas turbine engine, controllably spans a range from less than about 0.06 to at least 0.18.

In another embodiment, a propulsion and electric power generation system includes a dual-spool turbofan gas turbine engine and an electrical generator. The dual-spool turbofan gas turbine engine includes at least a high-pressure turbine, a low-pressure turbine, a fan, and a high-pressure compressor. The high-pressure turbine is coupled to the high-pressure compressor via a high-pressure spool. The low-pressure turbine is coupled, via a low-pressure spool and a speed reduction gear box, to the fan. The low-pressure turbine is configured to generate mechanical power. The electrical generator is directly coupled to the low-pressure spool and is disposed downstream of the low-pressure turbine. A first fraction of the mechanical power generated by the low-pressure turbine is controllably supplied to the fan for propulsive power generation (Pₜ). A second fraction of the mechanical power generated by the low-pressure turbine is controllably supplied to the electrical generator for electrical power generation (Pₑ). A ratio of Pₑ to Pₜ (Pₑ/Pₜ), during operation of the dual-spool turbofan gas turbine engine, controllably spans a range from less than about 0.06 to at least 0.18.

Furthermore, other desirable features and characteristics of the propulsion and electric power generation system will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 depicts a functional block diagram of one embodiment of a propulsion and electric power generation system; and

FIG. 2 depicts a partial cross-sectional view of an axial-centrifugal compressor that may be used in the system of FIG. 1.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

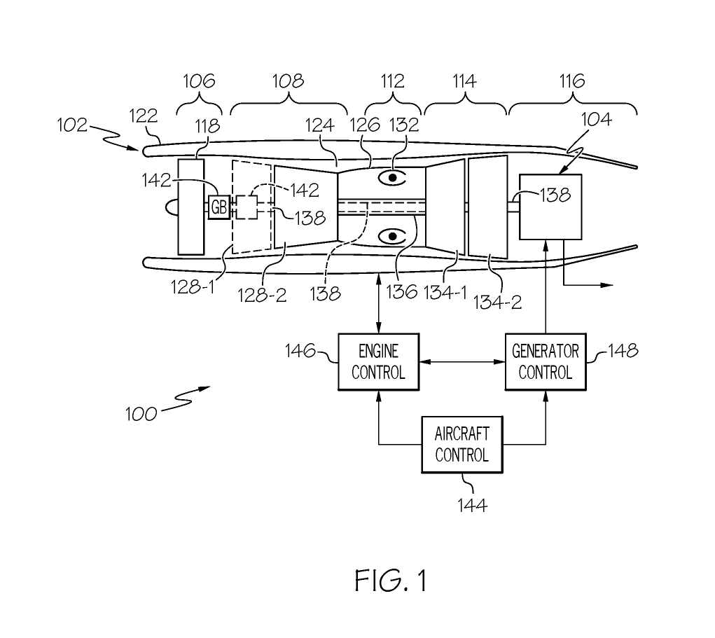

Turning now to FIG. 1, a functional block diagram of an exemplary propulsion and electric power generation system 100 is depicted. The depicted system 100 includes a gas turbine engine 102 and an electrical generator 104. The gas turbine engine is a dual-spool turbofan gas turbine engine 102, which includes an intake section 106, a compressor section 108, a combustion section 112, a turbine section 114, and an exhaust section 116. The intake section 106 includes a fan 118, which is mounted in a fan case 122. The fan 118 draws air into the intake section 106 and accelerates and pressurizes it. A fraction of the pressurized air exhausted from the fan 118 is directed through a bypass section 124 disposed between the fan case 122 and an engine cowl 126, and provides a forward thrust. The remaining fraction of air exhausted from the fan 118 is directed into the compressor section 108.

The compressor section 108 may include one or more compressors 128, which raise the pressure of the air directed into it from the fan 118, and directs the compressed air into the combustion section 112. In the depicted embodiment, two compressors are shown—a low-pressure compressor 128-1, and a high-pressure compressor 128-2. The low-pressure compressor 128-1 is depicted in phantom in FIG. 1 because in some embodiments the gas turbine engine 102 may be implemented without a separate low-pressure compressor 128-1. In such embodiments, the fan 118 may be implemented as a multi-stage fan 118.

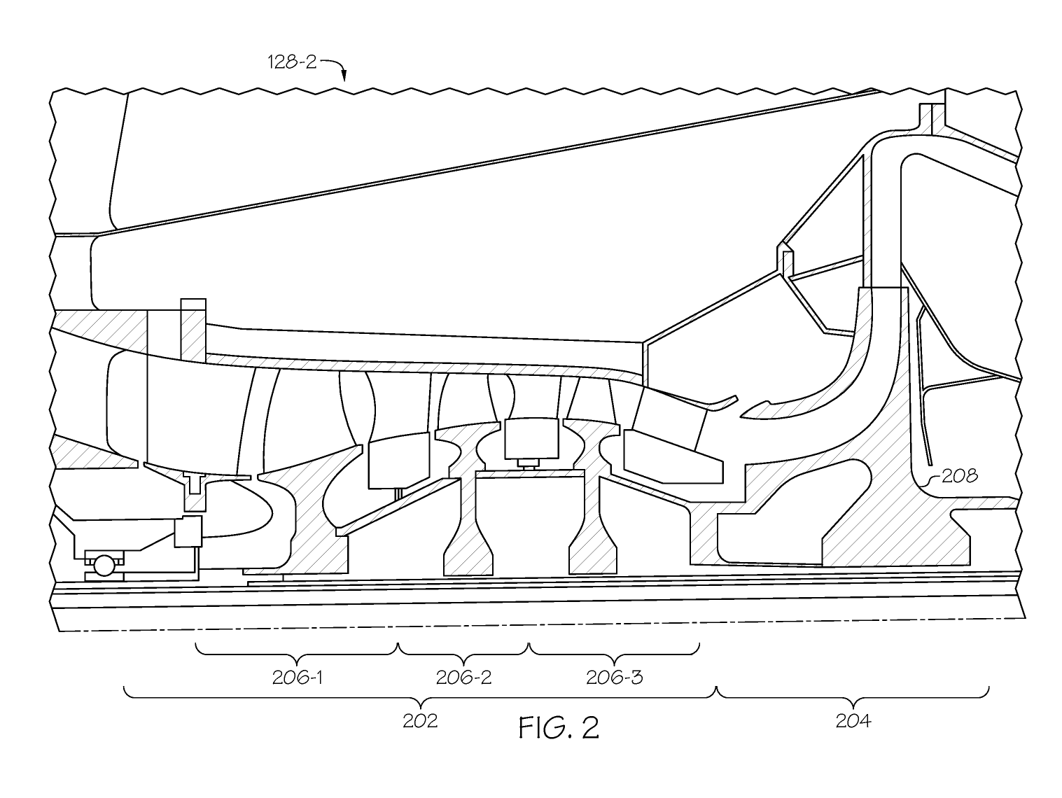

Whether or not the low-pressure compressor 128-1 is included, it will be appreciated that the high-pressure compressor 128-2 may be variously configured. For example, it may be configured as a multi-stage, axial-centrifugal compressor, or as multi-stage, axial compressor. For completeness, a partial cross-sectional view of an axial-centrifugal compressor is depicted in FIG. 2. The depicted high-pressure compressor 128-1 includes an axial section 202 and a centrifugal section 204. As is generally known, the axial section 202 includes a plurality of stages 206 (206-1, 206-2, 206-3). Although three stages are depicted, more or less than this number could be included. As is also generally known, the centrifugal section includes an impeller assembly 210 that compresses the air received from the axial section 202, and directs it radially outward. Although not depicted, the skilled artisan will readily understand that a multi-stage, all-axial compressor is configured similar to the axial section 202 of FIG. 2, and would not include the centrifugal section 204.

No matter the particular type of compressor that is used to implement the high-pressure compressor 128-2, the compressed air is directed into the combustion section 112. In the combustion section 112, which includes a combustor assembly 132, the compressed air is mixed with fuel that is controllably supplied to the combustor assembly 132 from a non-illustrated fuel source. The fuel and air mixture is combusted, and the high energy combusted air mixture is then directed into the turbine section 114.

The turbine section 114 includes one or more turbines 134. In the depicted embodiment, the turbine section 108 includes two turbines—a high-pressure turbine 134-1, and a low-pressure turbine 134-2. However, it will be appreciated that the engine 100 could be configured with more or less than this number of turbines. No matter the particular number, the combusted air mixture from the combustion section 106 expands through each turbine 134-1, 134-2, causing it to rotate. The combusted air mixture is then exhausted from the exhaust section 116, providing additional forward thrust. As the turbines 134-1, 134-2 rotate, each drives equipment in the engine 100 via concentrically disposed shafts or spools. Specifically, the high-pressure turbine 134-1 drives the high-pressure compressor 128-2 via a high-pressure spool 136, and the low-pressure turbine 134-2 drives the low-pressure compressor 128-1 (if included) and the fan 118 via a low-pressure spool 138.

As FIG. 1 also depicts, the gas turbine engine 102 may also, at least in some embodiments, include a speed reduction gear box 142. The speed reduction gear box, when included, is generally disposed between the low-pressure turbine 134-2 and the fan 118. In some embodiments, the speed reduction gear box 142 is disposed between the low-pressure compressor 128-1 (if included) and the fan 118. In other embodiments, which is also depicted in phantom in FIG. 1, the speed reduction gear box 142 is disposed within or aft of the low-pressure compressor 128-1 (if included), such that one or more stages of the low-pressure compressor 128-1 are disposed upstream of the speed reduction gear box 142.

The electrical generator 104 is coupled to the low-pressure spool 138, and is disposed downstream of the low-pressure turbine 134-2. More specifically, the electrical generator 104 is directly coupled to the low-pressure spool 138 with no reduction gearing between the low-pressure turbine 134-2 and the electrical generator 104. The electrical generator 104 may be implemented using any one of numerous types of electrical generators. In one embodiment, the electrical generator 104 is implemented using a high-efficiency wound field generator that is configured to generate up to at least 1.0 megawatt (MW) of electrical power (AC or rectified to 300 VDC or 600 VDC) with an efficiency of about 97%. It will be appreciated, however, that the electrical generator 104 may be configured to generate more or less than this amount of electrical power. For example, it may be configured to generate electrical power in a range from 200 kW to 1.5 MW.

Returning to FIG. 1, the depicted system 100 additionally includes, for example, an aircraft control 144, an engine control 146, and a generator control 148. The aircraft control 144 controls the overall operation of the system 100 based on propulsion and electrical demand on the system. The engine control 146 is coupled to receive commands from the aircraft control 144 and feedback from both the generator control 148 and various non-illustrated sensors in the engine 102. The engine control 146 is configured, in response to the commands and feedback it receives, to control fuel flow to the engine 102. The generator control 148 is coupled to receive commands from the aircraft control 144 and feedback from the engine control 146. The generator control 144 is configured, in response to the commands and feedback it receives, to control the electrical power generated and supplied by the electrical generator 104 to various, non-illustrated electrical loads.

Because the low-pressure turbine 134-2 is coupled to the fan 118 and the electrical generator 104 (and in some embodiments the low-pressure compressor 128-1), the mechanical power generated by the low-pressure turbine 128-1 is used for both propulsive power generation and electrical power generation. More specifically, a first fraction of the mechanical power generated by the low-pressure turbine 134-2 is controllably supplied to the fan 118 (and low-pressure compressor 128-1, if included) for propulsive power generation (Pₜ), and a second fraction of the mechanical power generated by the low-pressure turbine 134-2 is controllably supplied to the electrical generator 104 for electrical power generation (Pₑ). The engine 102, as will be discussed in more detail momentarily, is configured, in some embodiments, such that a ratio of Pₑ to Pₜ (Pₑ/Pₜ), during engine operation, controllably spans a range from less than about 0.06 to at least 0.18. In other embodiments, the ratio of Pₑ to Pₜ (Pₑ/Pₜ), during engine operation, controllably spans a range from less than about 0.06 to at least 0.24. In still other embodiments, the ratio of Pₑ to Pₜ (Pₑ/Pₜ), during engine operation, controllably spans a range from less than about 0.06 to at least 0.3. In yet other embodiments, the ratio of Pₑ to Pₜ (Pₑ/Pₜ), during engine operation, controllably spans a range from less than about 0.06 to at least 0.4.

One of the challenges associated with large variations in Pₑ/Pₜ is the concomitantly large changes in compressor operating conditions. Namely, it puts the compressor, and more specifically the high-pressure compressor 128-2, at risk of stall or surge. Moreover, the more rapid the change in Pₑ, the more likely a compressor surge. Thus, the high-pressure compressor 128-2 is preferably configured to avoid stall or surge for the large variations in Pₑ/Pₜ and for rapid changes in Pₑ. To this end, the high-pressure compressor 128-2 is designed according to certain parameters, depending on the type of compressor that is used to implement the high-pressure compressor 128-2.

For example, when the high-pressure compressor 128-2 is configured as a multi-stage, all-axial compressor, it is designed such that the axial pressure ratio per stage (i.e., ^{N}\sqrt{HPCOPR}) is less than 1.6, where HPCOPR is the total pressure ratio of the high-pressure compressor 128-2, and N is the number of stages in the high-pressure compressor 128-2. When the high-pressure compressor 128-2 is configured as a multi-stage, axial-centrifugal compressor, the centrifugal pressure ratio is greater than 20% of the axial pressure ratio, and the axial pressure ratio per stage is less than 2.0.

It was additionally noted above that the speed reduction gear box 142 is disposed between the low-pressure turbine 134-2 and the fan 118. This, at least in part, is so that the electrical generator 104 and fan 118 can be rotated at speeds that are at least close to nominal rotational speeds. As may be appreciated, the nominal speed of the electrical generator 104 is much higher than the fan 118. Thus, the speed reduction gear box 142 implements a gear ratio (GR). As used herein, the GR is defined as the fan speed/gear box output speed divided by the low-pressure turbine speed/gear box input speed. In the depicted embodiment, the gear ratio that is selected is based upon the bypass ratio (BPR) of the engine 102, which, as is generally known, is the ratio of the mass flow rate of the bypass stream to the mass flow rate entering the engine core. With this in mind, the gear ratio (GR) of the reduction gear box 142 is selected such that GR×√BPR is in a range of 0.5 to 1.5.

The propulsion and electric power generation system described herein enables electric power extraction from the propulsion engine at relatively high levels of Pₑ/Pₜ, without adversely impacting compressor operability by ensuring adequate stall and surge margin throughout the broad range of operation.

In one embodiment, a propulsion and electric power generation system includes a dual-spool turbofan gas turbine engine and an electrical generator. The dual-spool turbofan gas turbine engine includes at least a low-pressure turbine coupled to a fan via a low-pressure spool. The low-pressure turbine is configured to generate mechanical power. The electrical generator is directly connected to the low-pressure spool and is disposed downstream of the low-pressure turbine. A first fraction of the mechanical power generated by the low-pressure turbine is controllably supplied to the fan for propulsive power generation (Pₜ). A second fraction of the mechanical power generated by the low-pressure turbine is controllably supplied to the electrical generator for electrical power generation (Pₑ). A ratio of Pₑ to Pₜ (Pₑ/Pₜ), during operation of the dual-spool turbofan gas turbine engine, controllably spans a range from less than about 0.06 to at least 0.18.

These aspects and other embodiments may include one or more of the following features. The ratio of Pₑ to Pₜ (Pₑ/Pₜ), during operation of the dual-spool turbofan gas turbine engine, controllably spans a range from less than about 0.06 to at least 0.24. The ratio of Pₑ to Pₜ (Pₑ/Pₜ), during operation of the dual-spool turbofan gas turbine engine, controllably spans a range from less than about 0.06 to at least 0.3. The ratio of Pₑ to Pₜ (Pₑ/Pₜ), during operation of the dual-spool turbofan gas turbine engine, controllably spans a range from less than about 0.06 to at least 0.4. The electrical generator is configured to generate from 200 kilowatt to about 1.5 megawatt of electrical power. The dual-spool turbofan gas turbine engine further includes a high-pressure turbine coupled to a high-pressure compressor via a high-pressure spool, the high-pressure compressor is configured as a multi-stage, all-axial compressor having an axial pressure ratio per stage, and the axial pressure ratio per stage is less than 1.6. The dual-spool turbofan gas turbine engine further includes a high-pressure turbine coupled to a high-pressure compressor via a high-pressure spool, the high-pressure compressor is configured as a multi-stage, axial-centrifugal compressor having a centrifugal total pressure ratio, an axial total pressure ratio, and an axial pressure ratio per stage, the centrifugal total pressure ratio is greater than 20% of the axial total pressure ratio, and the axial pressure ratio per stage is less than 2.0. A speed reduction gear box is disposed between the low-pressure turbine and the fan. The dual-spool turbofan gas turbine engine further includes a low-pressure compressor coupled to the low-pressure turbine via the low-pressure spool, and the speed reduction gear box is disposed between the low-pressure compressor and the fan. One or more stages of the low-pressure compressor are disposed upstream of the speed reduction gear box. The dual-spool turbofan gas turbine engine exhibits a bypass ratio (BPR), the speed reduction gear box implements a gear ratio (GR), and the gear ratio of the reduction gear box is selected such that GR×√BPR is in a range of 0.5 to 1.5.

In another embodiment, a propulsion and electric power generation system includes a dual-spool turbofan gas turbine engine and an electrical generator. The dual-spool turbofan gas turbine engine includes at least a high-pressure turbine, a low-pressure turbine, a fan, and a high-pressure compressor. The high-pressure turbine is coupled to the high-pressure compressor via a high-pressure spool. The low-pressure turbine is coupled, via a low-pressure spool and a speed reduction gear box, to the fan. The low-pressure turbine is configured to generate mechanical power. The electrical generator is directly coupled to the low-pressure spool and is disposed downstream of the low-pressure turbine. A first fraction of the mechanical power generated by the low-pressure turbine is controllably supplied to the fan for propulsive power generation (Pₜ). A second fraction of the mechanical power generated by the low-pressure turbine is controllably supplied to the electrical generator for electrical power generation (Pₑ). A ratio of Pₑ to Pₜ (Pₑ/Pₜ), during operation of the dual-spool turbofan gas turbine engine, controllably spans a range from less than about 0.06 to at least 0.18.

These aspects and other embodiments may include one or more of the following features. The ratio of Pₑ to Pₜ (Pₑ/Pₜ), during operation of the dual-spool turbofan gas turbine engine, controllably spans a range from less than about 0.06 to at least 0.24. The ratio of Pₑ to Pₜ (Pₑ/Pₜ), during operation of the dual-spool turbofan gas turbine engine, controllably spans a range from less than about 0.06 to at least 0.3. The ratio of Pₑ to Pₜ (Pₑ/Pₜ), during operation of the dual-spool turbofan gas turbine engine, controllably spans a range from less than about 0.06 to at least 0.4. The electrical generator is configured to generate from 200 kilowatt to about 1.5 megawatt of electrical power. The dual-spool turbofan gas turbine engine further includes a high-pressure turbine coupled to a high-pressure compressor via a high-pressure spool, the high-pressure compressor is configured as a multi-stage, all-axial compressor having an axial pressure ratio per stage, and the axial pressure ratio per stage is less than 1.6. The dual-spool turbofan gas turbine engine further includes a high-pressure turbine coupled to a high-pressure compressor via a high-pressure spool, the high-pressure compressor is configured as a multi-stage, axial-centrifugal compressor having a centrifugal total pressure ratio, an axial total pressure ratio, and an axial pressure ratio per stage, the centrifugal total pressure ratio is greater than 20% of the axial total pressure ratio, and the axial pressure ratio per stage is less than 2.0. The dual-spool turbofan gas turbine engine further includes a low-pressure compressor coupled to the low-pressure turbine via the low-pressure spool, and the speed reduction gear box is disposed between the low-pressure compressor and the fan. The speed reduction gear box is disposed between the low-pressure compressor and the fan. One or more stages of the low-pressure compressor are disposed upstream of the speed reduction gear box. The dual-spool turbofan gas turbine engine exhibits a bypass ratio (BPR), the speed reduction gear box implements a gear ratio (GR), and the gear ratio of the reduction gear box is selected such that GR×√BPR is in a range of 0.5 to 1.5.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, the phrase “coupled to” used in describing a relationship between different elements do not imply that a direct physical connection must be made between these elements. For example, two elements may be connected to each other physically, electronically, logically, or in any other manner, through one or more additional elements.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A propulsion and electric power generation system, comprising:
a dual-spool turbofan gas turbine engine including at least a low-pressure turbine coupled to a fan via a low-pressure spool, the low-pressure turbine configured to generate mechanical power; and
an electrical generator directly connected to the low-pressure spool and disposed downstream of the low-pressure turbine,
wherein:
a first fraction of the mechanical power generated by the low-pressure turbine is controllably supplied to the fan for propulsive power generation (Pₜ),
a second fraction of the mechanical power generated by the low-pressure turbine is controllably supplied to the electrical generator for electrical power generation (Pₑ), and
a ratio of Pₑ to Pₜ (Pₑ/Pₜ), during operation of the dual-spool turbofan gas turbine engine, controllably spans a range from less than about 0.06 to at least 0.18.

2. The system of claim 1, wherein the ratio of Pₑ to Pₜ (Pₑ/Pₜ), during operation of the dual-spool turbofan gas turbine engine, controllably spans a range from less than about 0.06 to at least 0.24.

3. The system of claim 1, wherein the ratio of Pₑ to Pₜ (Pₑ/Pₜ), during operation of the dual-spool turbofan gas turbine engine, controllably spans a range from less than about 0.06 to at least 0.3.

4. The system of claim 1, wherein the ratio of Pₑ to Pₜ (Pₑ/Pₜ), during operation of the dual-spool turbofan gas turbine engine, controllably spans a range from less than about 0.06 to at least 0.4.

5. The system of claim 1, wherein the electrical generator is configured to generate from 200 kilowatt to about 1.5 megawatt of electrical power.

6. The system of claim 1, wherein:
the dual-spool turbofan gas turbine engine further includes a high-pressure turbine coupled to a high-pressure compressor via a high-pressure spool;
the high-pressure compressor is configured as a multi-stage, all-axial compressor having an axial pressure ratio per stage; and
the axial pressure ratio per stage is less than 1.6.

7. The system of claim 1, wherein:
the dual-spool turbofan gas turbine engine further includes a high-pressure turbine coupled to a high-pressure compressor via a high-pressure spool;
the high-pressure compressor is configured as a multi-stage, axial-centrifugal compressor having a centrifugal total pressure ratio, an axial total pressure ratio, and an axial pressure ratio per stage;
the centrifugal total pressure ratio is greater than 20% of the axial total pressure ratio; and
the axial pressure ratio per stage is less than 2.0.

8. The system of claim 1, further comprising:
a speed reduction gear box disposed between the low-pressure turbine and the fan.

9. The system of claim 8, wherein:
the dual-spool turbofan gas turbine engine further includes a low-pressure compressor coupled to the low-pressure turbine via the low-pressure spool; and
the speed reduction gear box is disposed between the low-pressure compressor and the fan.

10. The system of claim 8, wherein one or more stages of the low-pressure compressor are disposed upstream of the speed reduction gear box.

11. The system of claim 8, wherein:
the dual-spool turbofan gas turbine engine exhibits a bypass ratio (BPR);
the speed reduction gear box implements a gear ratio (GR); and
the gear ratio of the reduction gear box is selected such that GR×√BPR is in a range of 0.5 to 1.5.

12. A propulsion and electric power generation system, comprising:
a dual-spool turbofan gas turbine engine including at least a high-pressure turbine, a low-pressure turbine, a fan, and a high-pressure compressor, the high-pressure turbine coupled to the high-pressure compressor via a high-pressure spool, the low-pressure turbine coupled, via a low-pressure spool and a speed reduction gear box, to the fan, the low-pressure turbine configured to generate mechanical power; and
an electrical generator directly connected to the low-pressure spool and disposed downstream of the low-pressure turbine, the electrical generator configured to generate up to at least 1.0 megawatts of electrical power with about 97% efficiency,
wherein:
a first fraction of the mechanical power generated by the low-pressure turbine is controllably supplied to the fan for propulsive power generation (Pₜ),
a second fraction of the mechanical power generated by the low-pressure turbine is controllably supplied to the electrical generator for electrical power generation (Pₑ), and
a ratio of Pₑ to Pₜ (Pₑ/Pₜ), during operation of the dual-spool turbofan gas turbine engine, controllably spans a range from less than about 0.06 to at least 0.18.

13. The system of claim 12, wherein the ratio of Pₑ to Pₜ (Pₑ/Pₜ), during operation of the dual-spool turbofan gas turbine engine, controllably spans a range from less than about 0.06 to at least 0.24.

14. The system of claim 12, wherein the ratio of Pₑ to Pₜ (Pₑ/Pₜ), during operation of the dual-spool turbofan gas turbine engine, controllably spans a range from less than about 0.06 to at least 0.3.

15. The system of claim 12, wherein the ratio of Pₑ to Pₜ (Pₑ/Pₜ), during operation of the dual-spool turbofan gas turbine engine, controllably spans a range from less than about 0.06 to at least 0.4.

16. The system of claim 12, wherein:
the high-pressure compressor is configured as a multi-stage, all-axial compressor having an axial pressure ratio per stage; and
the axial pressure ratio per stage is less than 1.6.

17. The system of claim 12, wherein:
the high-pressure compressor is configured as a multi-stage, axial-centrifugal compressor having a centrifugal total pressure ratio, an axial total pressure ratio, and an axial pressure ratio per stage;
the centrifugal total pressure ratio is greater than 20% of the axial total pressure ratio; and
the axial pressure ratio per stage is less than 2.0.

18. The system of claim 12, wherein:
the dual-spool turbofan gas turbine engine further includes a low-pressure compressor coupled to the low-pressure turbine via the low-pressure spool; and
the speed reduction gear box is disposed between the low-pressure compressor and the fan.

19. The system of claim 18, wherein one or more stages of the low-pressure compressor are disposed upstream of the speed reduction gear box.

20. The system of claim 12, wherein:
the dual-spool turbofan gas turbine engine exhibits a bypass ratio (BPR);
the speed reduction gear box implements a gear ratio (GR); and
the gear ratio of the reduction gear box is selected such that GR×√BPR is in a range of 0.5 to 1.5.
